(19) United States
(12) Patent Application Publication
(10) Pub. No.: US 2023/0119051 A1
(43) Pub. Date: Apr. 20, 2023

(54) METHOD AND APPARATUS FOR CONSTRUCTING FPGA CHIP TOP-LEVEL SCHEMATIC AND STORAGE MEDIUM

(71) Applicant: SHENZHEN PANGO MICROSYSTEMS CO.,LTD., Shenzhen City (CN)

(72) Inventors: Zhihui YANG, Shenzhen City (CN); Puxia LIU, Shenzhen City (CN); Qipan FU, Shenzhen City (CN)

(73) Assignee: SHENZHEN PANGO MICROSYSTEMS CO.,LTD., Shenzhen City (CN)

(21) Appl. No.: 17/906,979

(22) PCT Filed: Mar. 24, 2021
(86) PCT No.: PCT/CN2021/082532

§ 371 Date: Sep. 22, 2022

(30) Foreign Application Priority Data
Sep. 14, 2020 (CN) 202010961779.9

(51) Int. Cl. G06F 30/347

(52) U.S. Cl. CPC G06F 30/347

(57) ABSTRACT

A method and apparatus for constructing an FPGA chip top-level schematic, and a storage medium are disclosed. The method comprises: integrating several PRIM devices into one grid device; integrating several grid devices into one tile device; abstracting each tile device into a corresponding tile device symbol; according to a predefined interconnection requirement, constructing each tile device symbol into a tile interconnection line symbol of at least one corresponding form; and integrating several tile interconnection line symbols into a top-level schematic. By means of the method, a hierarchical design is used, such that multi-form tile interconnection line symbols can be realized, thereby improving the working efficiency of system integration, and improving the high reliability, verifiability and easy-iteration of system integration.

### FIELD OF THE INVENTION

The instant invention relates to the field of programmable logic device, in particular to a method and apparatus for constructing an FPGA chip top-level schematic, and a storage medium.

### BACKGROUND

FPGA (Field-Programmable Gate Array) is a product of development on the basis of programmable devices such as PAL (Programmable Array Logic) and CPLD (Complex Programmable Logic Device). It appears as a semi-custom circuit in the field of ASIC, which not only solves the shortcomings of the custom circuit, but also overcomes the shortcomings of the limited number of gate circuits in original programmable device.

The present ASIC system integration technology in the art cannot meet the relevant work requirements of FPGA chips. Therefore, it is necessary to apply for an integration method of chip system suitable for FPGA chip development.

### SUMMARY

An object of the invention is to provide a method and apparatus for constructing an FPGA chip top-level schematic, and a storage medium, in order to solve the technical problem that the FPGA chip is not easy to integrate in the existing technology.

The technical solution of the invention is as follows:

a method for constructing an FPGA chip top-level schematic which comprises:

integrating several PRIM devices into one grid device;

integrating several grid devices into one tile device;

abstracting each tile device into a corresponding tile device symbol;

according to a predefined interconnection requirement, constructing each tile device into a tile interconnection line symbol of at least one corresponding form, wherein each of the tile interconnection line symbols includes several communication ports; and

integrating several tile interconnection line symbols into a top-level schematic.

Preferably, the step of “integrating several PRIM devices into one grid device comprises” integrating several PRIM devices and special logic units for storing configuration points into a grid device schematic.

Preferably, the PRIM device includes at least one cell electronics.

Preferably, different tile device achieve different functions.

Preferably, the predefined interconnection requirement comprises the physical layout of the connections between the PRIM devices in different tile devices.

Preferably, after integrating several tile interconnection line symbols into a top-level schematic, the method further comprises verifying the architecture information of the top-level schematic according to different tile interconnection line symbols.

Another technical solution of the invention is as follows: an apparatus for constructing an FPGA chip top-level schematic which comprises:

a first integration module for integrating several PRIM devices into one grid device;

a second integration module for integrating several grid devices into one tile device;

an abstract module for abstracting each tile device into a corresponding tile device symbol;

a morphological building block for according to a predefined interconnection requirement, constructing each tile device symbol into a tile interconnection line symbol of at least one corresponding form, wherein each of the tile interconnection line symbols includes several communication ports; and

a third integration module, for integrating several tile interconnection line symbols into a top-level schematic.

Preferably, the apparatus further comprises a verification module for verifying the architecture information of the top-level schematic according to different tile interconnection line symbols.

Another technical solution of the invention is as follows: an apparatus for constructing an FPGA chip top-level schematic which includes a processor and a memory coupled to the processor, the memory stores program instructions. The processor is configured to execute the program instructions of memory storage in order to execute the above-mentioned method for constructing a top-level circuit of the FPGA chip.

Another technical solution of the invention is as follows: a storage medium which stores program instructions, and when the program instructions are executed by a processor, the above-mentioned method for constructing an FPGA chip top-level schematic is implemented.

The invention provides a method and apparatus for constructing an FPGA chip top-level schematic, and a storage medium. The method comprises: integrating several PRIM devices into one grid device; integrating several grid devices into one tile device; abstracting each tile device into a corresponding tile device symbol; according to a predefined interconnection requirement, constructing each tile device symbol into a tile interconnection line symbol of at least one corresponding form; and integrating several tile interconnection line symbols into a top-level schematic, by means of which, a hierarchical design is used such that multi-form tile interconnection line symbols can be realized, thereby improving the working efficiency of system integration and improving the high reliability, verifiability and easy-iteration of system integration.

### BRIEF DESCRIPTION OF THE DRAWINGS

FIG. 1 illustrates the flow chart of the method for constructing an FPGA chip top-level schematic in a first embodiment of the invention;

FIG. 2 illustrates the construction schematic diagram of the method for constructing an FPGA chip top-level schematic in the first embodiment of the invention;

FIG. 3 illustrates the structural schematic of the tile interconnection line symbols of the first form in the method for constructing an FPGA chip top-level schematic in the first embodiment of the invention;

FIG. 4 illustrates the structural schematic of the tile interconnection line symbols of a second form in the method for constructing an FPGA chip top-level schematic in the first embodiment of the invention;

FIG. 5 illustrates the structural schematic of the tile interconnection line symbols of a third form in the method for constructing an FPGA chip top-level schematic in the first embodiment of the invention;

FIG. 6 illustrates the structural schematic of the top-level circuit in the method for constructing an FPGA chip top-level schematic in the first embodiment;

FIG. 7 illustrates the structural schematic of the apparatus for constructing an FPGA chip top-level schematic in the second embodiment;

FIG. 8 illustrates the structural schematic of the apparatus for constructing an FPGA chip top-level schematic in the third embodiment; and

FIG. 9 illustrates the structural schematic of the storage medium in a fourth embodiment of the invention.

### DETAILED DESCRIPTION OF THE INVENTION

In order to make the purpose, technical solution and advantages of this specification clearer, the technical solution of this specification will be clearly and completely described in combination with the specific implementation examples of this specification and the corresponding appended drawings. Obviously, the described implementation is only part of this specification, not all of it. Based on the embodiments in this specification, all other embodiments obtained by ordinary technicians in the art without creative work belong to the scope of protection in this specification. It should be noted that the embodiments and features in the embodiments in the invention can be combined with each other without conflict.

The terms “first”, “second” and “third” in the description, claims and the above drawings of the invention are used to distinguish different objects, rather than to describe a specific order. In addition, the term “includes” and any variations thereof are intended to cover non exclusive inclusion. For example, a process, method, system, product or equipment containing a series of steps or units is not limited to the listed steps or units, but optionally also includes the steps or units not listed, or optionally includes other steps or units fixed to these processes, methods, products or equipment.

Referring to “embodiments” herein, it means that the particular features, structures or features described in combination with embodiments may be included in at least one embodiments of the invention. The occurrence of the phrase at various points in the specification does not necessarily refer to the same embodiments, nor are they independent or alternative embodiments mutually exclusive with other embodiments. It is understood explicitly and implicitly by those skilled in the field that the embodiments described here can be combined with other embodiments.

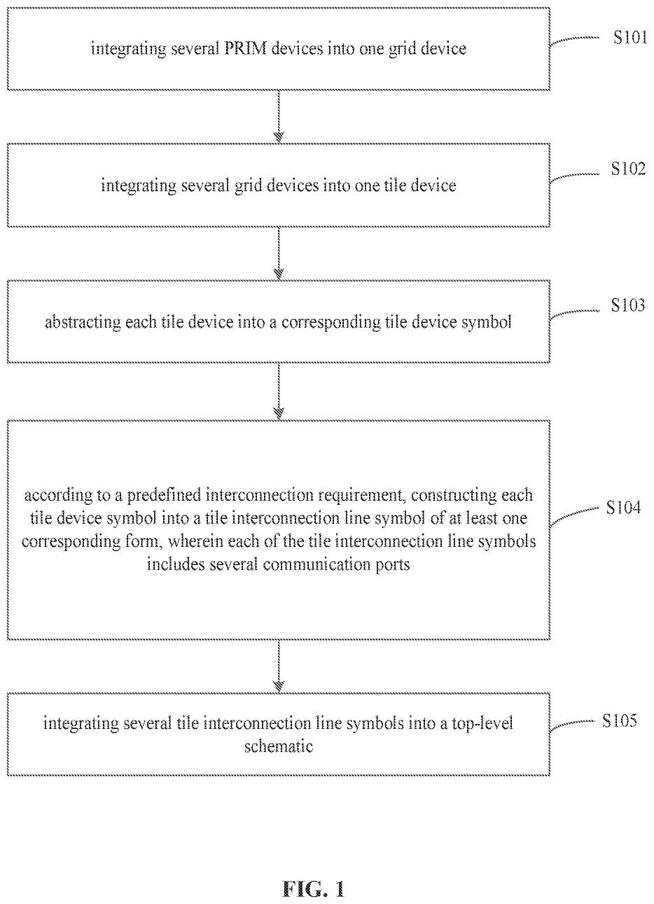

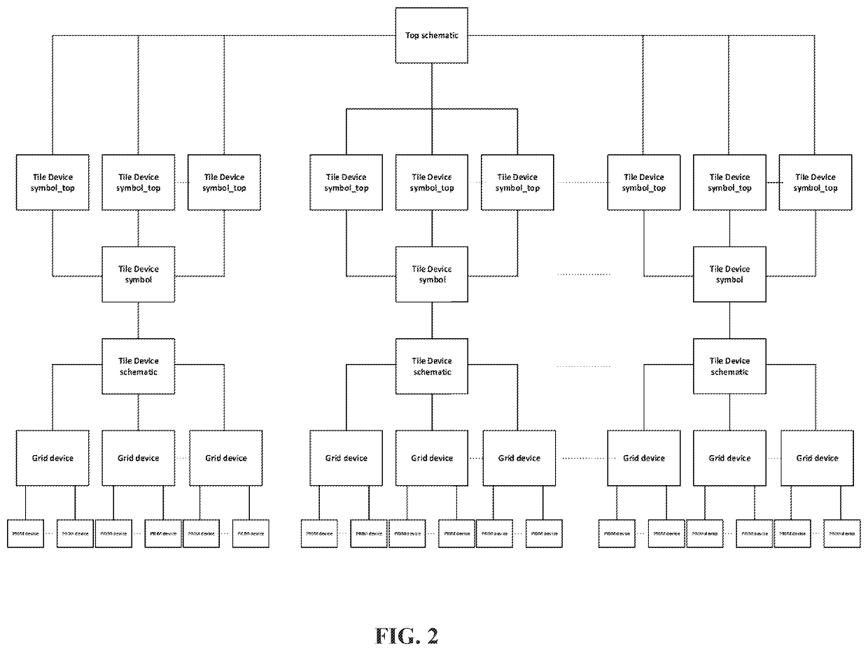

FIG. 1 illustrates the flow chart of the method for constructing an FPGA chip top-level schematic in the first embodiment of the invention. It should be noted that the method of the invention is not limited to the process sequence shown in FIG. 1 if substantially the same results are obtained. As shown in FIG. 1 and FIG. 2, the method for constructing top-level circuit of the FPGA chip includes step S101, integrating several PRIM devices into one grid device. In this embodiment, the PRIM device includes at least one unit electronic device, and the PRIM device may be a register, nand gate, or NOR gate. Several PRIM devices are integrated into a grid device. In this step, several PRIM devices are integrated into one grid device, which is hardware integration.

The method includes S102, integrating several grid devices into one tile device. In this embodiment, tile device which is hardware integration, is a hardware module formed by several grid devices. Different tile device realize different functions.

In an alternative embodiment, the tile device consists of several grid devices and a special logic unit, which is a special grid device used to store configuration points. In this step, several grid devices and special logic units for storing configuration points are integrated into a tile device.

The method includes S103, abstracting each tile device into a corresponding tile device symbol. In this embodiment, the construction of the top-level circuit is completed on the basis of the design of tile device symbol. And by cadence the tile device is abstracted into the corresponding tile device symbol. The tile device symbol is a level of hardware modularization, which is a virtual level and to facilitate the generation of bit stream file.

The method includes S104, according to a predefined interconnection requirement, constructing each tile device symbol into a tile interconnection line symbol of at least one corresponding form, wherein each of the tile interconnection line symbols includes several communication ports.

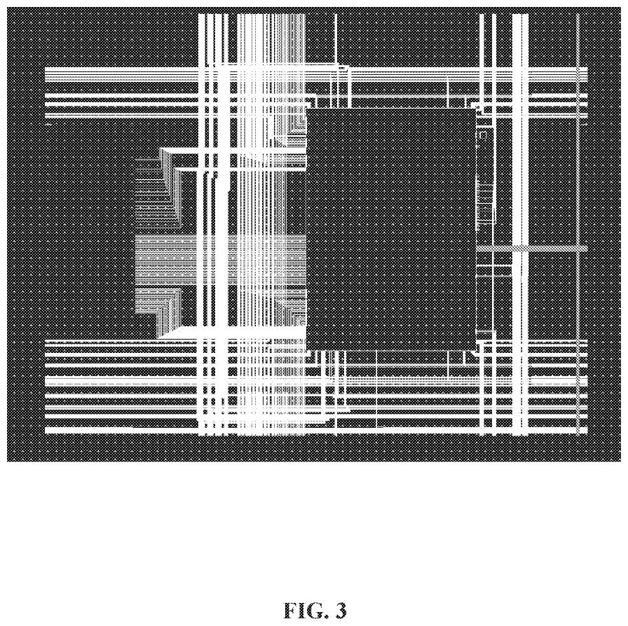

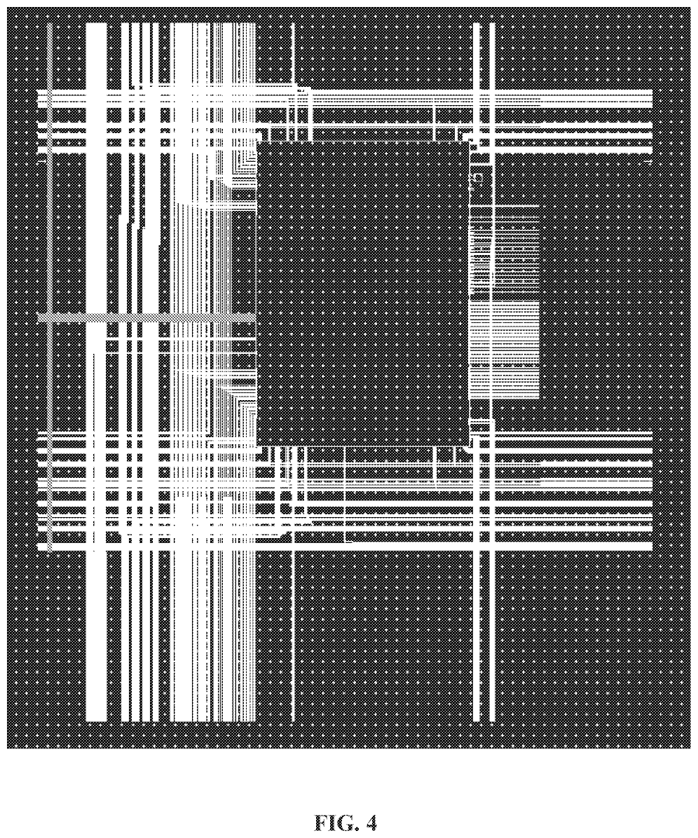

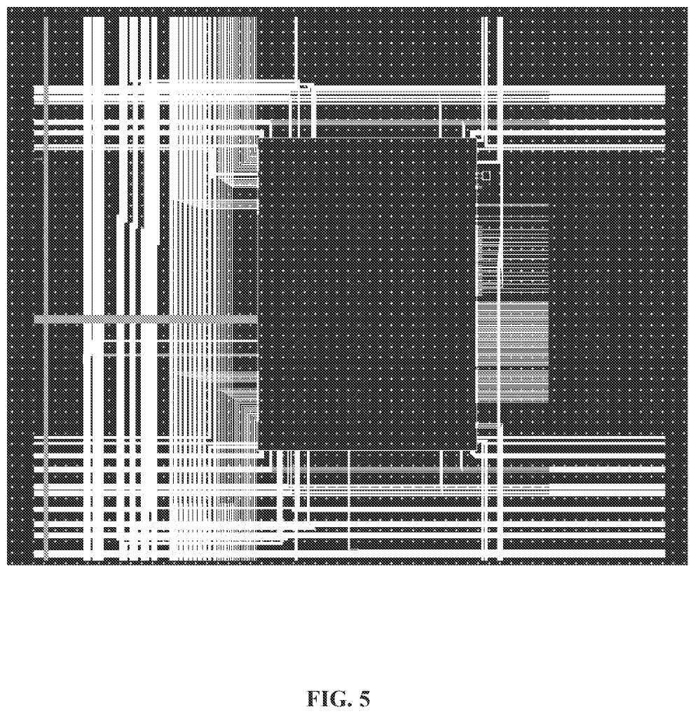

In this step, the construction of tile interconnection line symbol is to carry out the top-level symbol design. According to the full-chip design specifications, the system architecture engineer realizes and completes the design of various symbol forms of each tile device symbol. The core of this design is that all symbol forms need to achieve the interconnection requirements of the architecture. In order to achieve the two-dimensional plane to build a complete circuit design architecture diagram. The core of its architectural constraints is the interconnection requirements of the architecture for tile device signal ports, while the core of symbol with various forms are the various layout of tile device signal ports under this requirement. Please refer to FIG. 3 to FIG. 5, which respectively are three different forms of the tile interconnection line symbols of the same tile device.

In this step, the predefined interconnection requirement comprises:

The method includes S105, integrating several tile interconnection line symbols into a top-level schematic.

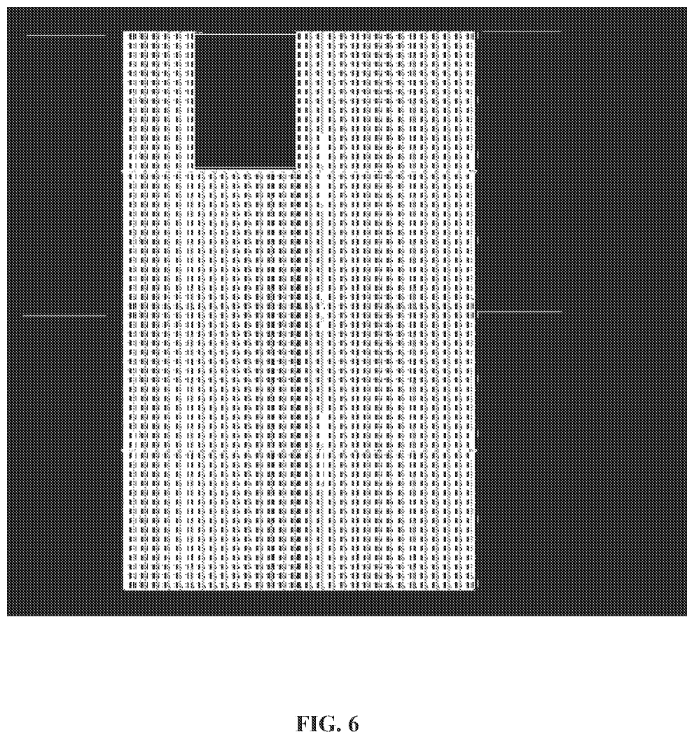

In this step, based on the construction of all symbol forms of the tile device, the integration of all symbols are completed according to the chip architecture. The chip general diagram contains all the circuit design information of the whole chip, as shown in FIG. 6. The top-level circuit is hardware, composed of several tile devices and the tile interconnection line symbols between them. Each cell of the top-level circuit is provided with a tile device. At the level of the top structure model, the tile device presents a 2D layout under the grid system specification.

In this embodiment, a method to create a top-level circuit based on the idea of hierarchical design is constructed, especially the idea of integrating the total circuit diagram based on the polymorphic symbol. This method can ensure high reliability, verifiability and easy iteration of system integration.

In an alternative embodiment, step S105 is followed by S106, verifying the architecture information of the top-level schematic according to different tile interconnection line symbols.

A technical solution for realizing the method in this embodiment is as follows:

the architecture of FPGA being divided into the following various levels of devices, which are formed in a hierarchical manner. The types of devices from bottom to top include: the lowest logical unit named PRIM device; the basic logical unit named grid device; a special basic logical unit which is different from normal grid device, which doesn't contain user-programmable resources and is used to store configuration points. It is named CRAM device. A level which is between the grid device and the top-level structural model is consisted of several grid devices and CRAM devices and is named tile devices. The top-level structure model named architecture device contains only the integration of tile devices.

The top-level circuit constructed by the method of this embodiment has the following usage scenarios:

First, design specification: according to the module design specifications and the tile device design specifications provided by the FPGA software design process, the system architecture engineer formulates the model design specifications that conform to the internal use of the hardware in this project.

Second, module design: according to the module design specification and the model design specification document discussed and decided by the software and hardware, the system architecture engineer and the module design engineer jointly carry out the module design, which specifically includes the model design of each level of device and each abstraction level.

Third, top-level symbol design: according to the full chip design specifications, the system architect implements and completes the design of various symbol forms of each tile device module. The core of this design is that all symbol forms need to jointly realize the interconnection requirements of the architecture.

Fourth, verification design: verification engineers formulate a verification plan according to the architecture specification, and complete the verification of the top-level circuit and architecture.

Firth, layout design: the layout engineer completes the layout design and verification based on the top-level circuit.

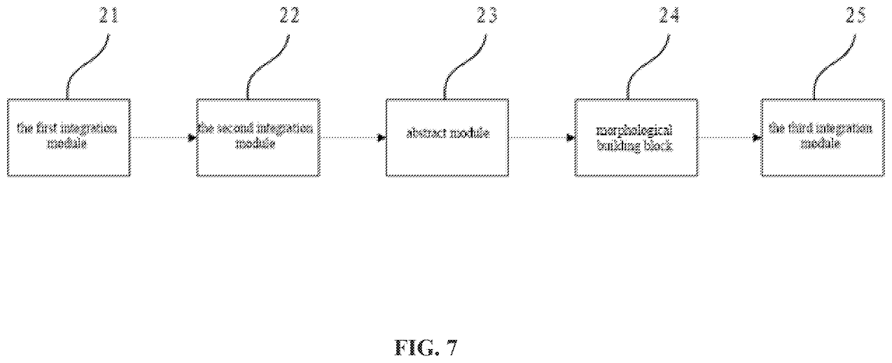

FIG. 7 illustrates the schematic diagram of the apparatus for constructing FPGA chip top-level schematic in the second embodiment. As shown in FIG. 7, the apparatus 20 includes a first integration module 21, a second integration module 22, an abstract module 23, a morphological building block 24 and a third integration module 25. The first integration module 21 is for integrating several PRIM devices into one grid device. The second integration module 22 is for integrating several grid devices into one tile device. The abstract module 23 is for abstracting each tile device into a corresponding tile device symbol. The morphological building block 24 is for according to a predefined interconnection requirement, constructing each tile device symbol into a tile interconnection line symbol of at least one corresponding form, wherein each of tile interconnection line symbols includes several communication ports. The third integration module 25 is for integrating several tile interconnection line symbols into a top-level schematic.

Further, the apparatus 20 also includes a verification module, which is used to verifying the architecture information of the top-level schematic according to different tile interconnection line symbols.

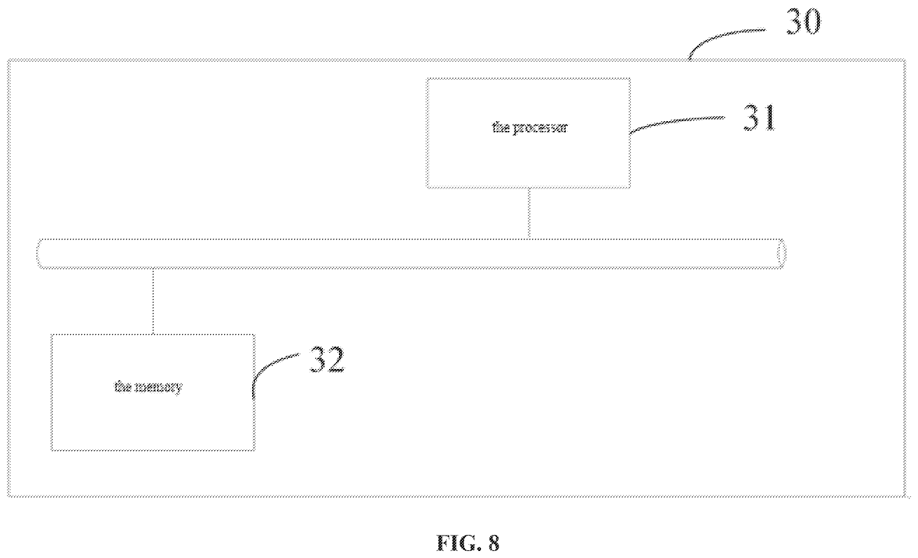

FIG. 8 illustrates the schematic diagram of the apparatus for constructing FPGA chip top-level schematic in the third embodiment. As shown in FIG. 8, the apparatus 30 for constructing the top-level circuit of the FPGA chip includes a processor 31 and a memory 32 coupled to the processor 31.

The memory 32 stores program instructions for implementing the method for constructing the top-level circuit of the FPGA chip in any of the foregoing embodiments.

The processor 31 is configured to execute the program instructions stored in the memory 42 to construct the top-level circuit of the FPGA chip.

The processor 31 may also be referred to as a CPU (Central Processing Unit). The processor 31 may be an integrated circuit chip with signal processing capability. The processor 31 may also be a general purpose processor, Digital Signal Processor (DSP), invention specific integrated circuit (ASIC), Field Programmable Gate Array (FPGA) or other programmable logic device, discrete gate or transistor logic device, discrete hardware components. A general purpose processor may be a microprocessor or the processor may be any conventional processor or the like.

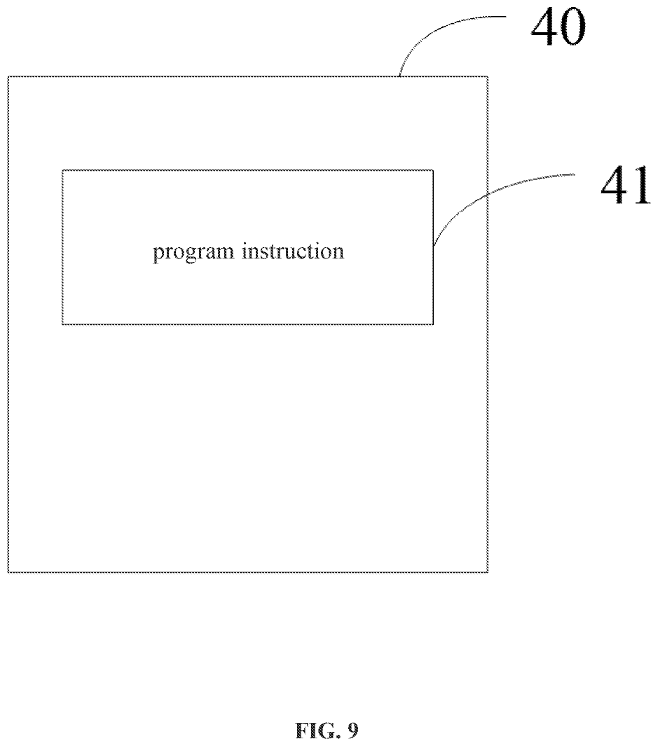

Referring to FIG. 9, the storage medium 40 in this embodiment of the invention stores program instructions 41 capable of implementing the construction methods for all the above-mentioned top-level circuits of FPGA chips, wherein the program instructions 41 may be stored in the above-mentioned storage medium in the form of software products, which includes several instructions for a computer device (which may be a personal computer, a server, or a network device, etc.) or a processor to execute all or part of the steps of the methods described in the various embodiments of the invention. The aforementioned storage devices include: U disk, removable hard disk, ROM (Read-Only Memory), RAM (Random Access Memory), magnetic disk or optical disk and other media that can store program codes, or terminal devices such as computers, servers, mobile phones, and tablets.

In the several embodiments provided in the invention, it should be understood that the disclosed system, apparatus and method may be implemented in other manners. For example, the device embodiments described above are only illustrative. For example, the division of units is only a logical function division. In actual implementation, there may be other division methods. For example, multiple units or components may be combined or integrated to another system, or some features can be ignored, or not implemented. On the other hand, the shown or discussed mutual coupling or direct coupling or communication connection may be through some interfaces, indirect coupling or communication connection of devices or units, and may be in electrical, mechanical or other forms.

In addition, each functional unit in each embodiment of the invention may be integrated into one processing unit, or each unit may exist physically alone, or two or more units may be integrated into one unit. The above-mentioned integrated units may be implemented in the form of hardware, or may be implemented in the form of software functional units. The above are only the embodiments of the invention, and are not intended to limit the scope of the patent of the invention. Any equivalent structure or equivalent process transformation made by using the contents of the description and drawings of the invention, or directly or indirectly applied in other related technical fields, all are similarly included in the scope of patent protection of the invention.

The above is only the embodiment of the invention. It should be pointed out here that ordinary technicians in the art can make improvements without departing from the spirit of the invention, but these shall fall into the protection scope of the invention.

What is claimed is:

1. A method for constructing an FPGA chip top-level schematic comprising:
integrating several PRIM devices into one grid device;
integrating several grid devices into one tile device;
abstracting each tile device into a corresponding tile device symbol;
constructing each tile device symbol into a tile interconnection line symbol of at least one corresponding form according to a predefined interconnection requirement, each of the tile interconnection line symbols including several communication ports; and
integrating several tile interconnection line symbols into a top-level schematic.

2. The method of claim 1, wherein the step “integrating several PRIM devices into one grid device” comprises a step of integrating several PRIM devices and special logic units for storing configuration points into a grid device schematic.

3. The method of claim 1, wherein the PRIM device includes at least one cell electronics.

4. The method of claim 1, wherein different tile devices achieve different functions.

5. The method of claim 1, wherein the predefined interconnection requirement comprises the physical layout of the connections between the PRIM devices in different tile devices.

6. The method of claim 1, wherein after integrating several tile interconnection line symbols into a top-level schematic, the method further comprises a step of verifying the architecture information of the top-level schematic according to different tile interconnection line symbols.

7. An apparatus for constructing an FPGA chip top-level schematic comprising:
a first integration module for integrating several PRIM devices into one grid device;
a second integration module for integrating several grid devices into one tile device;
an abstract module for abstracting each tile device into a corresponding tile device symbol;
a morphological building block for constructing each tile device symbol into a tile interconnection line symbol of at least one corresponding form according to a predefined interconnection requirement, in which each of the tile interconnection line symbols includes several communication ports; and
a third integration module for integrating several tile interconnection line symbols into a top-level schematic.

8. The apparatus of claim 7, wherein the apparatus further comprises a verification module for verifying the architecture information of the top-level schematic according to different tile interconnection line symbols.

9. An apparatus for constructing an FPGA chip top-level schematic, the apparatus comprising a processor and a memory storing program instructions coupled to the processor; the processor being configured to execute the program instructions of memory storage in order to implement the method for constructing an FPGA chip top-level schematic which comprises:
integrating several PRIM devices into one grid device;
integrating several grid devices into one tile device;
abstracting each tile device into a corresponding tile device symbol;
constructing each tile device symbol into a tile interconnection line symbol of at least one corresponding form according to a predefined interconnection requirement, each of the tile interconnection line symbols including several communication ports; and
integrating several tile interconnection line symbols into a top-level schematic.

10. (canceled)

11. The apparatus of claim 9, wherein the step “integrating several PRIM devices into one grid device” comprises a step of integrating several PRIM devices and special logic units for storing configuration points into a grid device schematic.

12. The apparatus of claim 9, wherein the PRIM device includes at least one cell electronics.

13. The apparatus of claim 9, wherein different tile devices achieve different functions.

14. The apparatus of claim 9, wherein the predefined interconnection requirement comprises the physical layout of the connections between the PRIM devices in different tile devices.

15. The apparatus of claim 9, wherein after integrating several tile interconnection line symbols into a top-level schematic, the method further comprises a step of verifying the architecture information of the top-level schematic according to different tile interconnection line symbols.
